(19) United States
(12) Patent Application Publication
(10) Pub. No.: US 2025/0127187 A1
(43) Pub. Date: Apr. 24, 2025

(54) METHOD FOR MANUFACTURING VANILLA PRODUCT

(71) Applicant: Sung-Yen Liu, Taitung City (TW)

(72) Inventor: Sung-Yen Liu, Taitung City (TW)

(21) Appl. No.: 18/611,819

(22) Filed: Mar. 21, 2024

(30) Foreign Application Priority Data
Oct. 20, 2023 (TW) 112140288

(51) Int. Cl. A23G 3/48; A23G 3/34; A23L 27/10

(52) U.S. Cl. CPC A23G 3/48; A23G 3/0012; A23L 27/115

(57) ABSTRACT

A method for manufacturing a vanilla product includes: (a) subjecting a vanilla pod to a crushing treatment to destroy tissue structures of the vanilla pod so as to obtain crushed particles of the vanilla pod; (b) placing the crushed particles of the vanilla pod into a container, followed by sealing the container; and (c) after step (b), heating the crushed particles of the vanilla pod in the container at a temperature ranging from 40° C. to 65° C., so as to obtain the vanilla product having aroma molecules.

### CROSS-REFERENCE TO RELATED APPLICATION

This application claims priority to Taiwanese Invention Patent Application No. 112140288, filed on Oct. 20, 2023, and incorporated by reference herein in its entirety.

### FIELD

The disclosure relates to a method for manufacturing a herbal product, and more particularly to a method for manufacturing a processed vanilla product.

### BACKGROUND

Vanilla is a common flavoring material that may be obtained by subjecting vanilla pods or beans to a series of processing steps, such as curing and purification. Vanillin, which is an edible and gourmet ingredient in vanilla, is a major compound widely used as a flavoring in food. When an edible raw material, e.g., cream, is flavored with vanillin, a fragrant aroma is created in a subsequently obtained food made from such edible raw material. The food may be, for instance, vanilla ice cream, vanilla cake and vanilla biscuits. Since vanillin can be applied to a variety of food materials and emanates a fragrant aroma that is popular among the public, vanillin is widely applied in food industries.

Referring to FIG. 1, a conventional method for manufacturing a vanilla product may include the following three steps: The first step (P1) (abbreviated as “preliminary step”) involves placing vanilla beans (usually beans of Vanilla planifolia, beans of Vanilla tahitensis or beans of Vanilla pompona) in a dry container that is in communication with an exterior environment; the second step (P2) (abbreviated as “killing and curing step”) involves subjecting the vanilla beans to a killing treatment and a curing treatment by heating the vanilla beans in the dry container, so as to allow the vanilla beans to cure and ripen to obtain a cured vanilla beans that produces vanillin; and the third step (P3) (abbreviated as “crushing step”) involves crushing the cured vanilla beans, thereby obtaining the vanilla product. At this point, the vanilla product is ready for direct consumption. If a user would like to further utilize the vanillin containing in the vanilla product, the vanilla product can be subjected to an extraction treatment using an organic solvent, thereby obtaining an extracted flavoring having a higher vanillin concentration. Such extracted flavoring is suitable for making food, such as vanilla ice cream and vanilla cake.

However, in actual practice of the second step (i.e., the killing treatment and the curing treatment) of the conventional method, putrefaction usually occurs in the vanilla beans due to exposure to microorganisms in the exterior environment, causing a significant decrease in yield. Moreover, even if the vanilla product is successfully produced after completion of the third step of the conventional method, only approximately 1 g to 5 g of the vanillin can be obtained per 100 g of the vanilla product, as determined using the standard method of the agricultural industry of China (NY/T 483-2002). In view of the market demand for vanillin, the aforesaid vanillin concentration is not deemed high, so a further production of the extracted flavoring is necessary to meet the market demand, which means that a larger amount of the vanilla product is required to achieve a desired production capacity. As a result, the cost for preparing vanillin remains high due to a relatively low yield of the vanilla product caused by the putrefaction of the vanilla beans, and a relatively low vanillin content in the vanilla product obtained by the conventional method.

### SUMMARY

Therefore, an object of the disclosure is to provide a method for manufacturing a vanilla product, which can alleviate at least one of the drawbacks of the prior art. The method includes:
(a) subjecting a vanilla pod to a crushing treatment to destroy tissue structures of the vanilla pod so as to obtain crushed particles of the vanilla pod;
(b) placing the crushed particles of the vanilla pod into a container, followed by sealing the container; and
(c) after step (b), heating the crushed particles of the vanilla pod in the container at a temperature ranging from 40° C. to 65° C., so as to obtain the vanilla product having aroma molecules.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block flow chart illustrating a conventional method for manufacturing a vanilla product.

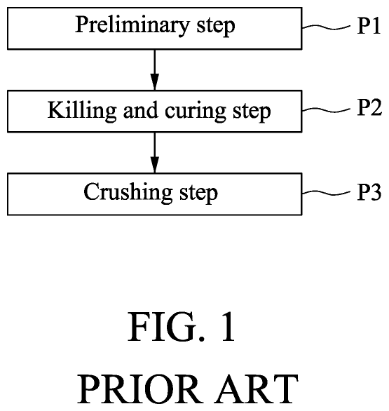

FIG. 2 is a block flow chart illustrating a first embodiment of a method for manufacturing a processed vanilla product according to the disclosure.

FIG. 3 is a diagram flow chart, in combination with FIG. 2, illustrates the first embodiment of the method for manufacturing the processed vanilla product according to the disclosure.

FIG. 4 is a block flow chart, in combination with FIG. 2, illustrates a sealing treatment conducted solely by vacuum evacuation in the first embodiment 2.

FIG. 5 is a block flow chart, in combination with FIG. 2, illustrates a sealing treatment conducted solely by introducing a stabilizing gas in the first embodiment.

FIG. 6 is a diagram flow chart, in combination with FIG. 2, illustrates a second embodiment of the method for manufacturing the processed vanilla product according to the disclosure.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

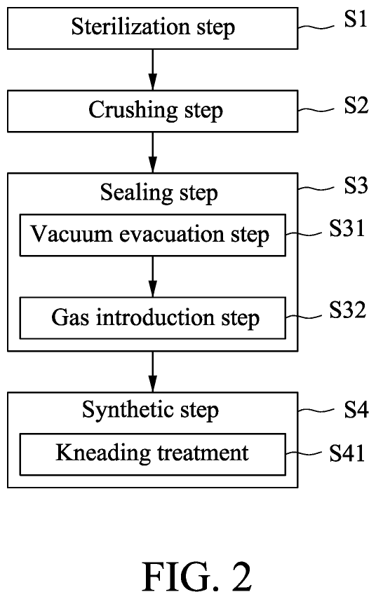

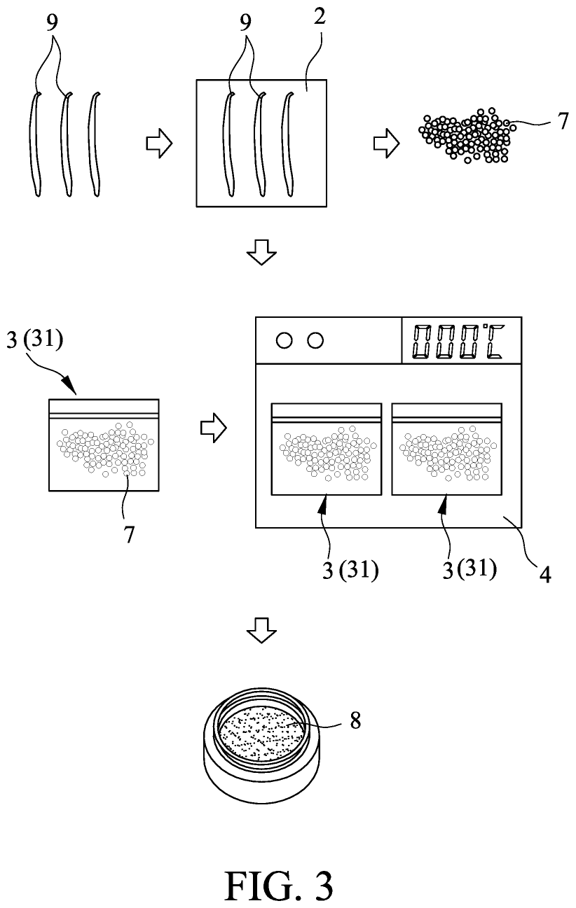

Referring to FIGS. 2 and 3, a first embodiment of a method for manufacturing a vanilla product 8 according to the present disclosure includes:
(a) subjecting a vanilla pod 9 to a crushing treatment to destroy tissue structures of the vanilla pod 9 so as to obtain crushed particles 7 of the vanilla pod 9;
(b) placing the crushed particles 7 of the vanilla pod 9 into a container 3, followed by sealing the container 3; and
(c) after step (b), heating the crushed particles 7 of the vanilla pod 9 in the container 3 at a temperature ranging from 40° C. to 65° C., so as to obtain the vanilla product 8 having aroma molecules.

In this embodiment, the method for manufacturing the vanilla product 8 further includes, prior to step (a), step (a)′ of subjecting the vanilla pod 9 a sterilization treatment.

The first embodiment is suitable for processing the vanilla pod 9 (usually pods of Vanilla planifolia, pods of Vanilla tahitensis, or pods of Vanilla pompona) which contains a precursor and an enzyme, so as to obtain the vanilla product 8 having the aroma molecules (e.g., vanillin). Specifically, the precursor may be glucovanillin, and the enzyme may be a glucosidase.

In order to sterilize the vanilla pod 9, in step (a)′ (referred to as “sterilization step (S1)” hereinafter), the sterilization treatment may be conducted utilizing a sterilization apparatus. In certain embodiments, the sterilization apparatus may be selected from the group consisting of an ultraviolet (UV) lamp, an ozone sterilizer, and a beaker for accommodating alcohol or hypochlorous acid water. In an exemplary embodiment, the sterilization apparatus is the ozone sterilizer, so that not only can microorganisms be effectively killed from a surface of the vanilla pod 9, but also eliminates an additional work time required to ensure that no liquid, such as alcohol or hypochlorous acid water, remains. In certain embodiments, the sterilization treatment may be conducted by a method selected form the group consisting of ultraviolet irradiation, ozone ventilation, alcohol immersion, hypochlorous acid water immersion, and combinations thereof, so that microorganisms remaining on the surface of the vanilla pod 9 are removed.

In step (a) (referred to as “crushing step (S2)” hereinafter), first, the vanilla pod 9 was mixed with a sterile water in a weight ratio ranging from 3:1 to 1:1, followed by the crushing treatment, so as to obtain the crushed particles 7 of the vanilla pod 9. Specifically, the crushing step (S2) involves placing the vanilla pod 9 into a homogenizing element 2, such as a blender or a homogenizer, followed by starting the homogenizing element 2, so that the vanilla pod 9 are crushed into the crushed particles 7 and then dispersed in the homogenizing element 2. To be specific, during the crushing treatment, tissue structures of the vanilla pod 9 are destroyed, so that the precursor and the enzyme are released from the tissue structures, thereby obtaining the crushed particles 7 of the vanilla pod 9. The crushed particles 7 of the vanilla pod 9 may have an average particle size of less than 2 mm.

In certain embodiments, in step (b) (referred to as “sealing step (S3)” hereinafter), sealing the container 3 may be conducted by subjecting the container 3 to vacuum evacuation. In certain embodiments, sealing the container 3 in the sealing step (S3) may be conducted by introducing a stabilizing gas into the container 3, so as to discharge a gas that is contained in the container 3. In this embodiment, the gas that is discharged out of the container 3 is oxygen. In certain embodiments, sealing the container 3 in the sealing step (S3) may be conducted by subjecting the container 3 to vacuum evacuation (referred to as “vacuum evacuation step (S31)” hereinafter), followed by introducing a stabilizing gas into the container 3 (referred to as “gas introduction step (S32)” hereinafter). In the first embodiment, sealing the container is performed using a sealing and packaging machine that has both vacuum-evacuation and inflating functions, so as to accomplish the vacuum evacuation step (S31) and the gas introduction step (S32).

In the first embodiment, the container 3 is an operating bag 31 that is made of a soft and kneadable material. Examples of the soft and kneadable material may include, but are not limited to, a transparent material, e.g., polyethylene (PE) or polypropylene (PP), and an aluminum foil composite material with a laminated structure. Utilization of the soft and kneadable material made of the polyethylene or the polyethylene allows those skilled in the art to directly observe filling of the operating bag 31 with the crushed particles 7 of the vanilla pod 9 from outside. In addition, the aluminum foil composite material not only exhibits properties of water resistance, gas resistance and light shielding, but also has an advantage in facilitating the packaging of the crushed particles 7 of vanilla pod 9 due to a supportive capacity provided by the laminated structure.

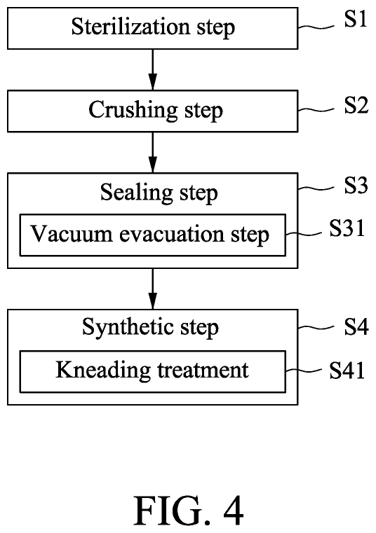

Referring to FIG. 4, in combination with FIGS. 2 and 3, sealing the container 3 is not limited to the approach as described above (i.e., the combination of both the vacuum evacuation step (S31) and the gas introduction step (S32)). For the purpose of discharging a gas out of the operating bag 31, in some embodiments, sealing the container 3 may be conducted by solely subjecting the operating bag 31 to the vacuum evacuation step (S31), so that the gas can be discharged out of the operating bag 31, thereby providing the operating bag 31 with a low-oxygen environment.

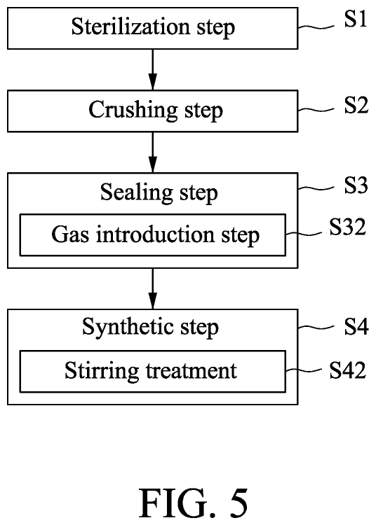

Referring to FIG. 5, in combination with FIGS. 2 and 3, in still some embodiments, sealing the container may be conducted solely by the gas introduction step (S32). Specifically, by introduction of the stabilizing gas into the operating bag 31, the gas is forced to be discharged out of the operating bag 31, so as to create a low-oxygen environment therein.

Referring to FIGS. 2 and 3, in the gas introduction step (S32), the stabilizing gas has a volume twice greater than the volume of the crushed particles 7 of the vanilla pod 9. Examples of the stabilizing gas may include, but are not limited to, nitrogen (N₂), carbon dioxide (CO₂), helium (He), neon (Ne), argon (Ar), krypton (Kr), xenon (Xe), and radon (Rn).

In step (c) (referred to as “synthetic step (S4)” hereinafter) of the first embodiment, the container 3 containing the crushed particles 7 of the vanilla pod 9 is placed into an oven 4 for conducting heating of the crushed particles 7, so as to allow a reaction between the precursor and the enzyme to proceed, and thus generate aroma molecules, thereby obtaining the vanilla product 8 containing the aroma molecules. In other words, the crushed particles 7 are converted into the vanilla product 8 containing the aroma molecules. In certain embodiments, heating the crushed particles 7 of the vanilla pod 9 in the container 3 is conducted at the temperature ranging from 50° C. to 60° C. Additionally, heating the crushed particles 7 of the vanilla pod 9 may last for a time period ranging from 2 days to 3 weeks. Under appropriate environmental conditions, the aroma molecules generated from the reaction is vanillin, which is a component that serves as a vital indicator of the quality of the vanilla product 8 in the subsequently conducted property evaluation.

In the synthetic step (S4) of the first embodiment, the container 3 is further subjected to a kneading treatment (S41) upon heating, so as to squeeze the crushed particles 7 of the vanilla pod 9 in the container 3, thereby mixing the precursor and the enzyme released from the tissue structures of the vanilla pod 9. Specifically, since the container 3 is the operating bag 31 that is made of the aforementioned soft and kneadable material, it would help a technician of the art to knead and squeeze the crushed particles 7 of the vanilla pod 9 in the operating bag 31, thereby attaining an effect of the precursor and the enzyme being evenly mixed.

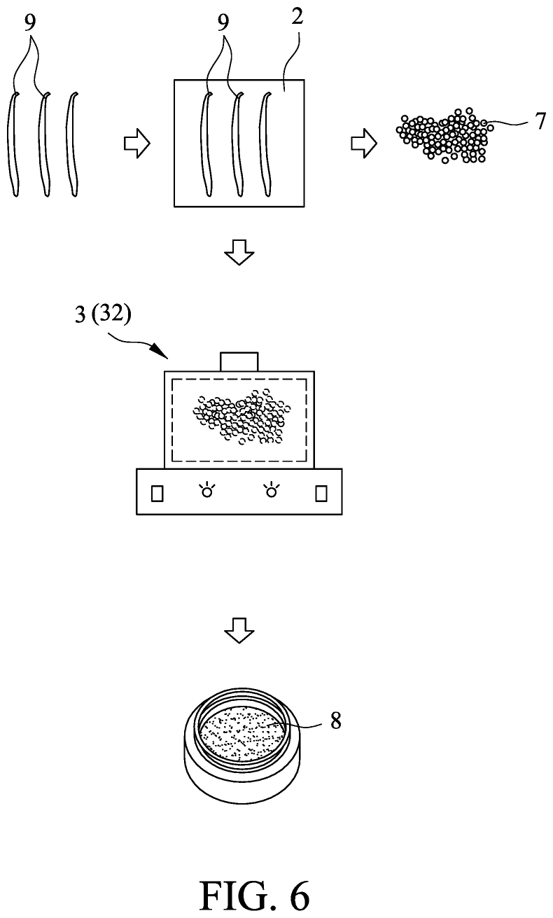

Referring to FIG. 6, a second embodiment of the method for manufacturing the vanilla product 8 according to the present disclosure is provided. Referring to FIG. 6, in combination with FIG. 2, the procedures of the second embodiment are substantially similar to those of the first embodiment, except that in the sealing step (S3), a rigid reaction tank 32, which has a heating and temperature control function and which is equipped with a stirring member (not shown) for stirring and well mixing the crushed particles 7 of the vanilla pod 9, is used in replacement of both the operating bag 31 and the oven 4 of the first embodiment, and a stirring treatment (S42) using the stirring member upon heating is adopted in replacement of the kneading treatment (S41) of the first embodiment. Specifically, the rigid reaction tank 32 has a function of introducing a desired stabilizing gas therein, and is capable of conducting sealing of the container 3, as well as the heating of the crushed particles 7 of the vanilla pod 9, so as to provide the crushed particles 7 of the vanilla pod 9 with a sealed and heated environment. In some embodiments, the rigid reaction rank 32 may be a large-volume tank which is made of a metal material or a glass material. In other embodiments, the stirring treatment (S42) is conducted by vortex stirring the crushed particles 7 of the vanilla pod 9 using a stirring member which may be a mixing blade or a stir bar.

To be specific, in the sealing step (S3) of the second embodiment, the crushed particles 7 of the vanilla pod 9 obtained in the crushing step (S2) are entirely poured into the rigid reaction tank 32, followed by sealing the rigid reaction tank 32. Thereafter, the crushed particles 7 of the vanilla pod 9 in the reaction tank 32 are heated (in the synthetic step (S4)), and also, upon heating, are further subjected to the stirring treatment (S42) for stirring the crushed particles 7 of the vanilla pod 9. Because both the sealing step (S3) and the synthetic step (S4) can be performed and completed in the rigid reaction tank 32, and because the rigid reaction tank 32 can accommodate a large amount of the crushed particles 7 of the vanilla pod 9 (compared to the operating bag 31 in the first embodiment), the second embodiment is favorable for the purpose of mass production of the vanilla product 8.

The disclosure will be further described by way of the following examples. However, it should be understood that the following examples are solely intended for the purpose of illustration and should not be construed as limiting the disclosure in practice.

### Example 1

The method of Example 1 includes subjecting vanilla pods 9 to the following steps (S1) to (S4).

First, in the sterilization step (S1), 1 kg of vanilla pods 9 was subjected to a sterilization treatment using an ozone sterilizer, thereby obtaining vanilla pods 9 having undergone the sterilization treatment.

Next, in the crushing step (S2), the vanilla pods 9 having undergone the sterilization treatment and a sterilized water were placed in a blender in a weight ratio of 2:1, and then subjected to a crushing treatment by starting the blender, so that the vanilla pods 9 were crushed into crushed particles 7 of the vanilla pods 9 having an average particle size of less than 2 mm.

Subsequently, in the sealing step (S3), the crushed particles 7 were distributed into three operating bags 31. Each of the operating bags 31 was then sealed by vacuum evacuation using a sealing and packaging machine, so that gas in the operating bag 31 was discharged out thereof, thereby obtaining three vacuumed bags each having the crushed particles 7 therein. After that, a nitrogen gas having a volume twice greater than that of the crushed particles 7 was introduced into one of the three vacuumed bags, so as to obtain a nitrogen-filled bag having the crushed particles 7 therein. In addition, a carbon dioxide gas having a volume twice greater than that of the crushed particles 7 was introduced into another one of the three vacuumed bags, so as to obtain a carbon dioxide-filled bag having the crushed particles 7 therein. The remaining vacuumed bag received no further introduction of gas.

Finally, in the synthetic step (S4), each of the vacuumed bag, the nitrogen-filled bag, and the carbon dioxide-filled bag was heated by placement into an oven 4 with a temperature controlled at 50° C. for 3 weeks, and, upon heating, was further subjected to a kneading treatment (S41) in which each of the bags was taken out from the oven 4 twice each day and kneaded for 1 minute each time, so as to squeeze the crushed particles 7 therein, thereby converting the crushed particles 7 into a vanilla product 8. The three vanilla products 8 thus obtained have a moisture content ranging from 87.4% to 88.3%.

### Comparative Example 1

The method of Comparative Example 1 includes subjecting vanilla pods to the following steps (1) to (3).

First, in step (1), 1 kg of vanilla pods was placed into an open container. Next, in step (2), the vanilla pods in the open container were subjected to a heating treatment, and thus was cured and ripened, so that vanillin was generated therein, thereby obtaining cured vanilla pods with vanillin. Subsequently, in step (3), the cured vanilla pods with vanillin were subjected to a grinding treatment, thereby obtaining vanilla products.

### <Property Evaluation>

### Determination of Vanillin Content

A respective one of the vanilla products 8 obtained in Example 1 and Comparative Example 1 was used as a test sample, and was subjected to determination of vanillin content in accordance with the procedures described in ISO 5565-2:1999 (last reviewed and confirmed in 2016). Briefly, an appropriate amount of the test sample was spread on a cylindrical filter paper, and then the cylindrical filter paper with the test sample spread thereon was placed in a Soxhlet extractor for extraction of vanillin, followed by determination of a vanillin content by high-performance liquid chromatography. The unit of the vanillin content was represented by the number of grams of vanillin per 100 g of dry weight of the test sample.

The results were shown in Table 1 below.

TABLE 1

| | Example 1 | | | |
|---|---|---|---|---|
| | Test sample | Test sample | Test sample | |
| | from | from | from carbon | |
| | vacuumed | nitrogen- | dioxide- | Comparative |
| | bag | filled bag | filled bag | Example 1 |
| Vanillin | 20.9 | 20.1 | 21.3 | 1-5 |
| content | | | | |
| (g/100 g of | | | | |
| dry weight of | | | | |
| test sample) | | | | |

### Determination of Moisture Content

A respective one of the vanilla products 8 obtained in Example 1 and Comparative Example 1 was used as a test sample, and was subjected to determination of moisture content using an electrical moisture meter.

By conducting crushing treatment in the crushing step (S2) of Example 1, tissue structures of the vanilla pods 8 having undergone the sterilization treatment were destroyed under the action of blades in the blender so that glucovanillin and a glucosidase in the tissue structures were released therefrom, which encouraged contact of the glucovanillin and the glucosidase and thus assisting a reaction therebetween to generate vanillin.

By conducting sealing of the container 3 in the sealing step (S3) of Example 1, the vanillin generated could be constrained in each of the vacuumed bag, the nitrogen-filled bag, and carbon dioxide-filled bag, so that a low yield of vanillin due to gasification and escape thereof could be avoided. In addition, because of conducting sealing of the container 3, moisture of the crushed particles 7 could be prevented from escaping to the external environment, so as to allow the crushed particles 7 to have a good moisture content, thereby maintaining fluidity of the crushed particles 7 due to good moisture content thereof, and therefore increasing the possibility of the contact between the glucovanillin and the glucosidase as well as facilitating the reaction therebetween.

By introducing the nitrogen gas or the carbon dioxide gas in the sealing step (S3) of Example 1, the nitrogen gas or the carbon dioxide gas would help the crushed particles 7 to be fully squeezed when the nitrogen-filled bag or the carbon dioxide-filled bag was subjected to the kneading treatment (S41) upon heating in the synthetic step (S4) of Example 1, thereby increasing the possibility of the contact between the glucovanillin and the glucosidase, and thus facilitating the reaction therebetween.

By introducing the nitrogen gas or the carbon dioxide gas in the sealing step (S3) of Example 1, the oxygen gas remaining in two of the vacuumed bags (i.e., two of the vacuum bags that would be subsequently introduced with the nitrogen gas or the carbon dioxide gas) could be discharged out therefrom, so that the nitrogen-filled bag or the carbon dioxide-filled bag obtained thereafter had a hypoxic environment, thereby preventing spoilage of the crushed particles 7 caused by microorganisms which usually depend on oxygen for survival, and thus increasing the yield of the vanilla product 8. In addition, in Example 1, not only was no mold observed in the vanilla product 8, but also the vanilla product 8 provided a rich aroma.

Accordingly, by conducting both the crushing treatment in the crushing step (S2) and the kneading treatment (S41) in the synthetic step (S4), the glucovanillin and the glucosidase can fully react with each other. Moreover, by conducting sealing of the container 3 in the sealing step (S3), the vanillin generated was well preserved. Referring to Table 1, the vanillin contents determined in the vanilla products 8 of Example 1, which ranges from 20.1 g to 21.3 g per 100 g of the test sample, are significantly higher than the vanillin contents determined in the vanilla products of Comparative Example 1, which ranges from 1 g to 5 per 100 g of the test sample, indicating that compared with Comparative Example 1, the vanillin contents of Example 1 were greatly increased. Moreover, no spoilage occurred in the vanilla products 8 of Example 1, and the aroma provided by the vanilla products 8 were stronger than that provided by the vanilla products of Comparative Example 1, suggesting that the problems of poor yield and relatively weak aroma of the vanilla products of Comparative Example 1, which were prepared by a conventional method, had been greatly improved.

### Example 2

The procedures for manufacturing the vanilla products 8 of Example 2 were generally similar to those of Example 1, except that in the sealing step (S3), four operating bags were used (i.e., four vanilla products 8 were obtained eventually), in which three of the four operating bags were respectively introduced with a nitrogen gas, a carbon dioxide gas, and an oxygen gas (for comparison purpose) after the vacuum evacuation step (S31), and in the synthetic step (S4), heating was conducted for 2 weeks. Additionally, the remaining vacuumed bag received no gas introduction.

The results were shown in Table 2 below.

TABLE 2

| | Example 2 | | | |
|---|---|---|---|---|
| | Test sample | Test sample | Test sample | Test sample |
| | from | from | from carbon | from |
| | vacuumed | nitrogen- | dioxide- | oxygen- |
| | bag | filled bag | filled bag | filled bag |
| Vanillin | 20.1 | 19.4 | 19.0 | 16.3 |
| content | | | | |
| (g/100 g of | | | | |
| dry weight of | | | | |
| test sample) | | | | |

Referring to Table 2, the vanillin contents determined in the vanilla products 8 obtained from the vacuumed bag, the nitrogen-filled bag, and the carbon dioxide-filled bag were higher than that determined in the vanilla product 8 obtained from the oxygen-filled bag. These results demonstrate that the occurrence of spoilage of the crushed particles 7 due to contact with microorganisms could be avoided, and failure of the reaction between glucovanillin and glucosidase due to contact thereof with oxygen and partial oxidation arising consequently could also be prevented.

In addition, owing to exposure to an oxygen-filled environment, the vanillin content determined in the vanilla product 8 obtained from the oxygen-filled bag was merely 16.3 g per 100 g of the test sample. In contrast, the vanillin content determined in the vanilla product 8 of the respective one of the vacuumed bag, the nitrogen-filled bag, and the carbon dioxide-filled bag, each of which had a hypoxic environment, increased to range from 19.0 g to 20.1 g per 100 g of the test sample, indicating that by exclusion of oxygen, the vanillin contents obtained after the synthetic step (S4) were significantly increased.

### Example 3

The procedures for manufacturing the vanilla products 8 of Example 3 were generally similar to those of Example 1, except that in the synthetic step (S4), heating was conducted for 2 days.

The results were shown in Table 3 below.

TABLE 3

| | Example 3 | | |
|---|---|---|---|
| | Test sample | Test sample | Test sample |
| | from vacuumed | from nitrogen- | from carbon |
| | bag | filled bag | dioxide-filled bag |
| Vanillin | 14.0 | 15.1 | 13.4 |
| content | | | |
| (g/100 g of dry | | | |
| wright of test | | | |
| sample) | | | |

Referring to Table 3, in combination with Table 1, when the time period of heating was extended to 3 weeks (i.e., as in Example 1), the vanillin contents increased to range from 20.1 g to 21.3 g per 100 g of the test sample, indicating that the vanillin contents in the vanillin products 8 were effectively elevated.

In summary, in the method for manufacturing the vanilla product 8 according to the disclosure, by conducting the crushing treatment in the crushing step (S2), the precursor and the enzyme can be released from the tissue structures, and by conducting sealing of the container 3 in the sealing step (S3), the crushed particles 7 of the vanilla pod 9 can be protected from being in contact with microorganisms originating from outside of the container 3, so that spoilage of the crushed particles 7 can be avoided and a desired moisture content thereof can be maintained. In addition, during the kneading treatment (S41) or the stirring treatment (S42) upon heating in the synthetic step (S4), a good fluidity of the crushed particles 7 can be attained due to the desired moisture content, which in turn facilitates the kneading treatment (S41) or the stirring treatment (S42), so as to allow the precursor and the enzyme to be well mixed and thus fully react with each other. Furthermore, because the container 3 provides a sealing environment, the aroma molecules (e.g., vanillin), due to gasification thereof, can be protected from escape to the external environment, thereby obtaining the vanilla product 8 having a high vanillin content.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a vanilla product, comprising:
(a) subjecting a vanilla pod to a crushing treatment to destroy tissue structures of the vanilla pod so as to obtain crushed particles of the vanilla pod;
(b) placing the crushed particles of the vanilla pod into a container, followed by sealing the container; and
(c) after step (b), heating the crushed particles of the vanilla pod in the container at a temperature ranging from 40° C. to 65° C., so as to obtain the vanilla product having aroma molecules.

2. The method as claimed in claim 1, wherein in step (b), sealing the container is conducted by vacuum evacuation.

3. The method as claimed in claim 1, wherein in step (b), sealing the container is conducted by introducing a stabilizing gas into the container, so as to discharge a gas that is contained in the container.

4. The method as claimed in claim 3, wherein the stabilizing gas is selected from the group consisting of nitrogen, carbon dioxide, helium, neon, argon, krypton, xenon, and radon.

5. The method as claimed in claim 4, wherein the stabilizing gas is nitrogen or carbon dioxide.

6. The method as claimed in claim 1, wherein in step (c), the container is further subjected to a kneading treatment upon heating.

7. The method as claimed in claim 6, wherein the container is an operating bag that is made of a soft and kneadable material.

8. The method as claimed in claim 1, wherein in step (c), the crushed particles of the vanilla pod in the container is further subjected to a stirring treatment upon heating.

9. The method as claimed in claim 8, wherein the container is a rigid reaction tank that has a heating and temperature control function, and is equipped with a stirring member.

10. The method as claimed in claim 1, further comprising, prior to step (a), step (a)′ of subjecting the vanilla pod to a sterilization treatment.

11. The method as claimed in claim 10, wherein the sterilization treatment is conducted by a method selected from the group consisting of ultraviolet irradiation, ozone ventilation, alcohol immersion, hypochlorous acid water immersion, and combinations thereof.

12. The method as claimed in claim 1, wherein in step (a), the crushed particles of the vanilla pod have an average particle size of less than 2 mm.

13. The method as claimed in claim 1, wherein in step (c), heating the crushed particles of the vanilla pod in the container is conducted at the temperature ranging 5 from 50° C. to 60° C.
